(19) United States
(12) Patent Application Publication
(10) Pub. No.: US 2009/0135118 A1
(43) Pub. Date: May 28, 2009

(54) LIQUID CRYSTAL DISPLAY DEVICE

(75) Inventors: Koji NOGUCHI, Kanagawa (JP); Tsuyoshi OHYAMA, Tokyo (JP); Koji ISHIZAKI, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/261,898

(22) Filed: Oct. 30, 2008

(30) Foreign Application Priority Data
Nov. 28, 2007 (JP) 2007-307865

(51) Int. Cl. G09G 3/36

(52) U.S. Cl. 345/87

(57) ABSTRACT

Disclosed herein is a liquid crystal display device having a pixel electrode in a shape of comb teeth, the pixel electrode including a plurality of comb tooth electrodes arranged in one direction, and having a reflective display section and a transmissive display section in each pixel, wherein the pixel electrode is formed such that width of the reflective display section is larger than width of the transmissive display section in a direction perpendicular to a direction of arrangement of the reflective display section and the transmissive display section, and the plurality of comb tooth electrodes are coupled to each other at only an end part.

### CROSS REFERENCES TO RELATED APPLICATIONS

The present invention contains subject matter related to Japanese Patent Application JP 2007-307865 filed in the Japan Patent Office on Nov. 28, 2007, the entire contents of which being incorporated herein by reference.

### BACKGROUND OF THE INVENTION

1. Field of the Invention

The present invention relates to a liquid crystal display device, and particularly to a transflective type liquid crystal display device that drives liquid crystal molecules in a transverse electric field mode.

2. Description of the Related Art

A liquid crystal display device in a transverse electric field mode is drawing attention as a liquid crystal display device in a liquid crystal mode that achieves a wide viewing angle and high contrast. In addition, recently, a transflective type liquid crystal display device whose viewability in a dark state and under extraneous light is improved has been applied widely as a liquid crystal display device for mobile use, and there is a desire to realize a transflective type liquid crystal display device to which a transverse electric field mode offering an excellent viewing angle characteristic is applied.

FIGS. 14A and 14B show a configuration of a transflective type liquid crystal display device to which a fringe field switching (FFS) mode as one transverse electric field mode is applied. A sectional view of FIG. 14A corresponds to a section A-A′ in a plan view of FIG. 14B. The liquid crystal display device 200 shown in these figures includes a light diffusing layer 3 having a projected and depressed diffusing surface formed thereon so as to correspond to a reflective display section 1r on a first substrate 1 having a pixel circuit formed thereon, and has a common electrode 5 formed of a transparent conductive film on the light diffusing layer 3. In addition, a reflecting layer 7 is provided on the common electrode 5 so as to correspond to the reflective display section 1r. The reflecting layer 7 also functions as a common electrode. An insulating film 9 is provided over the entire surface of the substrate 1 in a state of covering the reflecting layer 7 and the common electrode 5. A pixel electrode 11 in the shape of comb teeth is provided on the insulating film 9. The pixel electrode 11 has a plurality of comb tooth electrodes 11a extended in a direction of arrangement of the reflective display section 1r and a transmissive display section 1t. In addition, an alignment film 13 is provided in a state of covering such a pixel electrode 11.

On the other hand, a second substrate 21 has a color filter 23 formed thereon and has a black matrix formed thereon as required. An overcoat film 27 is provided in a state of covering the color filter 23 and the black matrix. A retardation layer 29 is pattern-formed at a position corresponding to the reflective display section 1r on the overcoat film 27. An alignment film 31 is provided in a state of covering the retardation layer 29. A liquid crystal layer LC is sealed in between the alignment films 13 and 31 of the first substrate 1 and the second substrate 21.

In the liquid crystal display device 200 of such a configuration, transmissive display sections 1t, which have excellent color reproducibility, need a certain pixel interval in order to prevent a color mixture between adjacent pixels. On the other hand, color reproducibility is not required of reflective display sections 1r, and therefore the pixel interval of the reflective display sections 1r can be made shorter than that of the transmissive display sections 1t. Therefore the width Wr of the pixel electrode 11 in the reflective display section 1r can be made larger than the width Wt of the pixel electrode 11 in the transmissive display section 1t. Further, while a black matrix is disposed between the transmissive display section 1t and the reflective display section 1r, a constitution can be made in which the black matrix is not disposed between adjacent reflective display sections 1r. In addition, a constitution has been proposed which increases transmitted light and reflected light by optimizing the pitches pr and pt of the comb tooth electrodes 11a of the pixel electrode 11 in the reflective display section 1r and the transmissive display section 1t (see “SID 07 DIGEST,” 2007, pp. 1651-1654).

### SUMMARY OF THE INVENTION

When the widths Wr and Wt and the pitches pr and pt of the pixel electrode 11 in the reflective display section 1r and the transmissive display section 1t are different from each other as shown in FIG. 14B, a bridge part 11b for connecting the comb tooth electrodes 11a to each other needs to be provided at a boundary surface part between the reflective display section 1r and the transmissive display section 1t in the pixel electrode 11. However, an electric field occurring between the comb tooth electrodes 11a in a direction parallel to the substrate 1 is disturbed in a region B around the bridge part 11b. A large disclination line occurs along the bridge part 11b at a time of white display. The occurrence of such a disclination line greatly decreases both reflectance and transmittance in the display device, and is thus a factor in degrading luminance.

Accordingly, it is desirable to provide a liquid crystal display device that can suppress the occurrence of a disclination line within a pixel electrode, and thereby make display at a high luminance.

According to an embodiment of the present invention, there is provided a liquid crystal display device having a pixel electrode in a shape of comb teeth, the pixel electrode including a plurality of comb tooth electrodes arranged in one direction, and having a reflective display section and a transmissive display section in each pixel, wherein the pixel electrode is formed such that width of the reflective display section is larger than width of the transmissive display section in a direction perpendicular to a direction of arrangement of the reflective display section and the transmissive display section, and the plurality of comb tooth electrodes are coupled to each other at only an end part.

In the liquid crystal display device of such a constitution, the pixel electrode is formed such that the width of the reflective display section is larger than the width of the transmissive display section. Therefore, when pixel electrodes are arranged in a same direction, an interval between pixel electrodes adjacent to each other in reflective display sections is shorter than an interval between the pixel electrodes adjacent to each other in transmissive display sections. Thereby, a color mixture is prevented and color reproducibility is ensured by securing an interval between adjacent pixels in the transmissive display sections inherently having excellent color reproducibility, while it is possible to make display with an effective aperture ratio secured by the large width of the pixel electrodes in the reflective display sections. Then, in particular, because the plurality of comb tooth electrodes are coupled to each other at only end parts, there is no electrode part that disturbs an electric field occurring between the comb tooth electrodes from the reflective display section to the transmissive display section, so that a uniform transverse electric field can be generated between the comb tooth electrodes over a wide area of the pixel electrode. Thereby a liquid crystal can be aligned uniformly over the part of the pixel electrode.

As described above, according to the present invention, it is possible to suppress the occurrence of a disclination line due to a disturbance of an electric field within a pixel and thereby make display at a high luminance while making liquid crystal display securing an aperture ratio and color reproducibility in the reflective display section and the transmissive display section.

### BRIEF DESCRIPTION OF THE DRAWINGS

FIG. 1 is a schematic sectional view of principal parts of one pixel of a liquid crystal display device according to a first embodiment;

FIG. 2 is a schematic plan view of principal parts of two pixels of the liquid crystal display device according to the first embodiment;

FIG. 3 is a diagram of assistance in explaining an example of optical configuration of the liquid crystal display device according to the first embodiment;

FIG. 4 is a schematic plan view of principal parts of two pixels of a liquid crystal display device according to a second embodiment;

FIG. 5 is a schematic sectional view of principal parts of one pixel of a liquid crystal display device according to a third embodiment;

FIG. 6 is a schematic plan view of principal parts of two pixels of the liquid crystal display device according to the third embodiment;

FIG. 7 is a diagram of assistance in explaining an example of optical configuration of the liquid crystal display device according to the third embodiment;

FIG. 8 is a diagram showing an example of a circuit configuration of a liquid crystal display device to which an embodiment of the present invention is applied;

FIG. 9 is a perspective view of a notebook personal computer to which an embodiment of the present invention is applied;

FIG. 10 is a perspective view of a video camera to which an embodiment of the present invention is applied;

FIG. 11 is a perspective view of a television set to which an embodiment of the present invention is applied;

FIGS. 12A and 12B are diagrams showing a digital camera to which an embodiment of the present invention is applied, FIG. 12A being a perspective view of the digital camera as viewed from a front side, and FIG. 12B being a perspective view of the digital camera as viewed from a back side;

FIGS. 13A to 13G are diagrams showing a portable terminal device, for example a portable telephone to which an embodiment of the present invention is applied, FIG. 13A being a front view of the portable telephone in an opened state, FIG. 13B being a side view of the portable telephone in the opened state, FIG. 13C being a front view of the portable telephone in a closed state, FIG. 13D being a left side view of the portable telephone in the closed state, FIG. 13E being a right side view of the portable telephone in the closed state, FIG. 13F being a top view of the portable telephone in the closed state, and FIG. 13G being a bottom view of the portable telephone in the closed state; and

FIGS. 14A and 14B are diagrams showing an example of a related-art liquid crystal display device in an FFS mode.

### DETAILED DESCRIPTION OF THE PREFERRED EMBODIMENTS

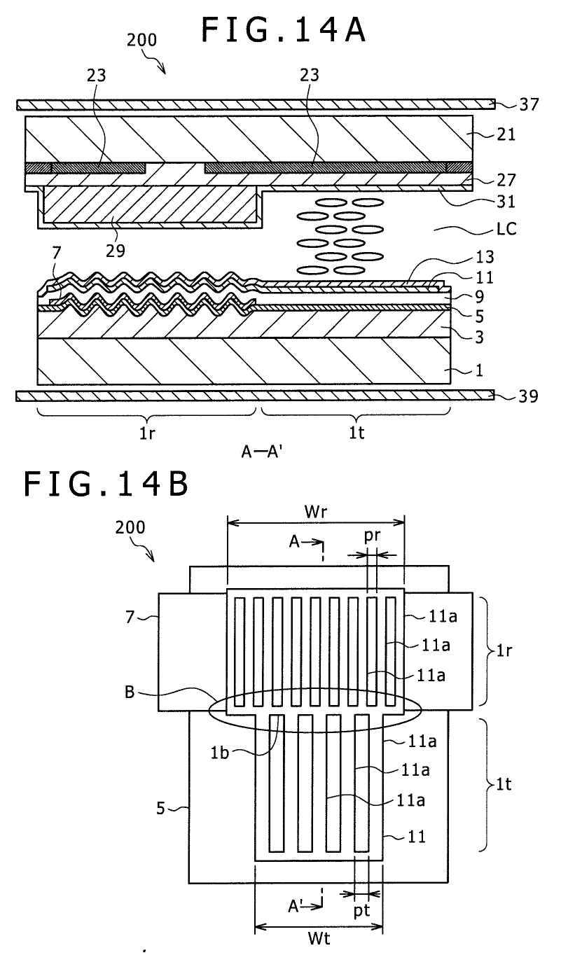

Preferred embodiments in which the present invention is applied to an FFS mode transflective type liquid crystal display device will hereinafter be described in detail with reference to the drawings. Incidentally, description of each embodiment will be made with the same constituent elements as in the related-art configuration described with reference to FIG. 14 identified by the same reference numerals.

### First Embodiment

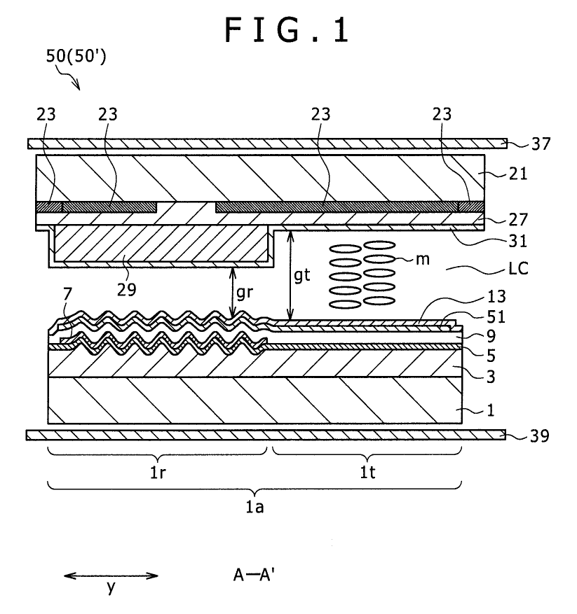

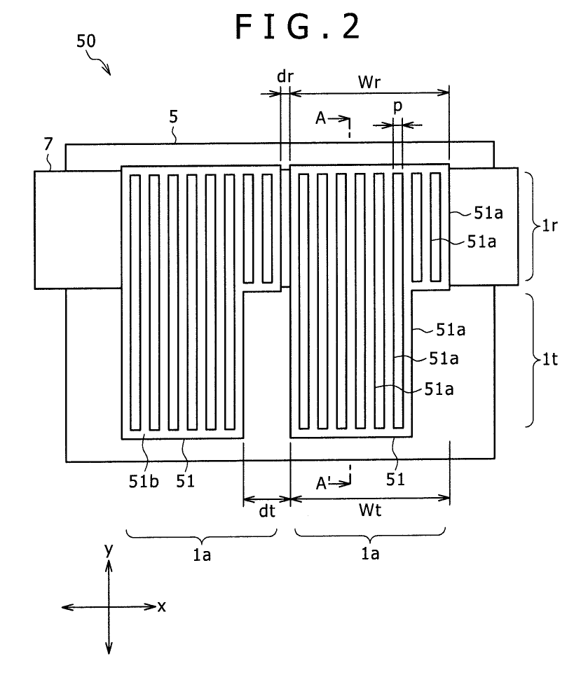

FIG. 1 is a schematic sectional view of principal parts of one pixel of a liquid crystal display device according to a first embodiment. FIG. 2 is a schematic plan view of principal parts of two pixels of the liquid crystal display device according to the first embodiment. A section A-A′ in this plan view corresponds to FIG. 1.

A difference between the liquid crystal display device 50 according to the first embodiment shown in these figures and the related-art liquid crystal display device shown in FIG. 14 lies in constitution of a pixel electrode 51. A detailed constitution of the liquid crystal display device 50 will be described with reference to these figures.

The liquid crystal display device 50 has a reflective display section 1r and a transmissive display section 1t disposed within each of a plurality of pixels 1a arranged in the form of a matrix. Suppose that each pixel 1a is for example of a rectangular shape having long sides in a vertical direction of a display screen, and that the reflective display section 1r and the transmissive display section 1t are arranged in this order in the direction of the long sides of each pixel 1a. Incidentally, hereinafter, a direction of arrangement of the reflective display section 1r and the transmissive display section 1t within each pixel 1a will be described as a vertical direction y, and a direction perpendicular to the direction of arrangement of the reflective display section 1r and the transmissive display section 1t will be described as a horizontal direction x.

Between pixels 1a and 1a adjacent to each other in the horizontal direction x, reflective display sections 1r are arranged so as to be adjacent to each other, and transmissive display sections 1t are arranged so as to be adjacent to each other. On the other hand, between pixels 1a and 1a adjacent to each other in the vertical direction y, transmissive display sections 1t may be arranged so as to be adjacent to reflective display sections 1r, or the reflective display sections 1r may be arranged so as to be adjacent to each other or the transmissive display sections 1t may be arranged so as to be adjacent to each other.

In the liquid crystal display device 50 having the reflective display section 1r and the transmissive display section 1t disposed within each pixel 1a, a pixel circuit not shown herein is disposed and formed at a part corresponding to each pixel 1a on an optically transparent first substrate 1. A light diffusing layer 3 having a projected and depressed diffusing surface formed thereon is provided at a part corresponding to the reflective display section 1r of each pixel 1a in a state of covering the upper surface of the first substrate 1. A common electrode 5 formed of a transparent conductive film is provided on the light diffusing layer 3 as a layer common to all pixels 1a, 1a, . . . . Suppose that the common electrode 5 is provided along the projected and depressed diffusing surface provided to the light diffusing layer 3.

A reflecting layer 7 is pattern-formed on the common electrode 5 so as to correspond to the reflective display section 1r. This reflecting layer 7 is provided along the projected and depressed diffusing surface of the surface of the common electrode 5, whereby the surface of the reflecting layer 7 is formed as a diffuse reflection surface. In addition, the reflecting layer 7 is provided as a common layer in the reflective display sections 1r of adjacent pixels 1a. That is, the reflecting layer 7 is provided as a common layer for a plurality of pixels 1a disposed so as to be adjacent to each other in the horizontal direction x among the pixels 1a. Such a reflecting layer 7 is formed of a conductive material having excellent light reflectivity such for example as aluminum (Al) or a high melting point metal material. Because the reflecting layer 7 is provided in contact with the upper surface of the common electrode 5, the reflecting layer 7 functions also as a part of the common electrode 5.

An insulating film 9 formed of an optically transparent material is provided on an entire surface over the substrate 1 in a state of covering the reflecting layer 7 and the common electrode 5. A pixel electrode 51 in the shape of comb teeth is provided on the insulating film 9. The pixel electrode 51 in the shape of comb teeth is made of a transparent conductive film, and is formed as follows.

The pixel electrode 51 in the shape of comb teeth is formed by a plurality of comb tooth electrodes 51a, and each comb tooth electrode 51a is extended in the vertical direction y as the direction of arrangement of the reflective display section 1r and the transmissive display section 1t. Suppose that the width and the arrangement interval p of the comb tooth electrodes 51a in the reflective display section 1r are substantially equal to the width and the arrangement interval p of the comb tooth electrodes 51a in the transmissive display section 1t, and that each comb tooth electrode 51a is formed by a straight line. Then, it is important that the plurality of comb tooth electrodes 51a be coupled to each other by a bridge electrode 51b at only end parts in the extending direction.

Furthermore, the pixel electrode 51 is formed such that the width Wr of the reflective display section 1r is larger than the width Wt of the transmissive display section 1t in the horizontal direction x as a direction of arrangement of the comb tooth electrodes 51a. The number of comb tooth electrodes 51a in the reflective display section 1r is therefore larger than the number of comb tooth electrodes 51a in the transmissive display section 1t, and is for example larger by two than the number of comb tooth electrodes 51a in the transmissive display section 1t in the example shown in FIG. 2. When the comb tooth electrodes 51a of the reflective display section 1r are increased by a plural number as compared with the transmissive display section 1t, all the increased comb tooth electrodes 51a may be disposed in one direction of the reflective display section 1r as shown in FIG. 2, or may be divided and disposed on both sides of the reflective display section 1r.

In addition, the pixel electrode 51 of such an external shape is disposed in each pixel 1a in a same direction. Therefore, between pixels 1a and 1a adjacent to each other in the horizontal direction x, an interval dr between pixel electrodes 51 in reflective display sections 1r is shorter than an interval dt between the pixel electrodes 51 in transmissive display sections 1t.

Incidentally, the pixel electrode 51 formed as described above is connected to a pixel circuit formed on the first substrate 1. In this case, suppose that when the pixel circuit is provided in a layer lower than the common electrode 5, an opening is provided in a necessary portion of the common electrode 5 and the reflecting layer 7 forming a part of the common electrode 5, and the pixel electrode 51 and the pixel circuit are connected to each other via a connection hole formed within the opening with insulation from the common electrode 5 and the reflecting layer 7 retained.

The pixel electrode 51 formed as described above is covered with an alignment film 13, so that the upper part of the first substrate 1 is formed.

A second substrate 21 is disposed so as to be opposed to the side of the surface where the alignment film 13 is formed in the first substrate 1 as described above. The second substrate 21 is formed of an optically transparent material. The second substrate 21 has a color filter 23 of each color that is pattern-formed in each pixel 1a as required on a surface of the second substrate 21 which surface faces the alignment film 13, and has a black matrix between pixels 1a.

Incidentally, a part of the color filter 23 is removed so as to correspond to the reflective display section 1r, for example, whereby attenuation of display light going and returning through the color filter 23 in the reflective display section 1r is adjusted.

An insulative overcoat film 27 is provided in a state of covering the color filter 23 and the black matrix as described above. A retardation layer 29 is pattern-formed at a position corresponding to the reflective display section 1r on the overcoat film 27. Suppose that this retardation layer 29 is formed with a phase difference of λ/2, for example. An alignment film 31 is provided in a state of covering the retardation layer 29, so that the upper part of the second substrate 21 is formed.

A spacer (not shown) is interposed between the alignment films 13 and 31 in the first substrate 1 and the second substrate 21 as described above. A liquid crystal layer LC is sealed in a gap between the alignment films 13 and 31. The liquid crystal layer LC is formed by using liquid crystal molecules m having positive or negative dielectric anisotropy. Suppose that the layer thickness of the liquid crystal layer LC in the reflective display section 1r (that is, a cell gap gr) and the layer thickness of the liquid crystal layer LC in the transmissive display section 1t (that is, a cell gap gt) in this case are adjusted by the film thickness of the retardation layer 29 according to an optical configuration to be described later. For example, suppose that these cell gaps gr and gt are set such that the liquid crystal layer LC in the reflective display section 1r has a phase difference of λ/4 and the liquid crystal layer LC in the transmissive display section 1t has a phase difference of λ/2 in a state in which voltage is applied between the pixel electrode 51 and the common electrode 5.

In addition, an emission side polarizer 37 and an incidence side polarizer 39 are disposed on the outside of the first substrate 1 and the second substrate 21. Further, a backlight not shown in the figures is disposed on the outside of the incidence side polarizer 39 disposed on the side of the first substrate 1, so that the liquid crystal display device 50 is formed.

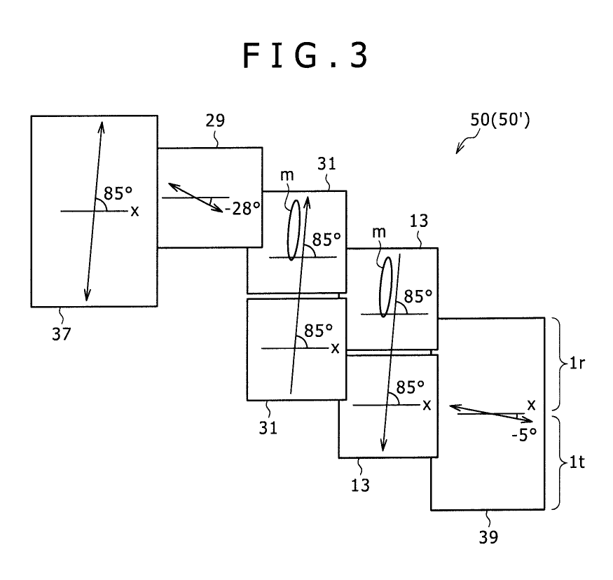

FIG. 3 is a diagram of assistance in explaining an example of optical configuration of such a liquid crystal display device 50. In FIG. 3, optical axes and alignment axes are indicated by arrows. Description will be made below of an example of optical configuration of the liquid crystal display device 50 while referring to FIG. 1 and FIG. 2 described earlier together with FIG. 3.

As shown in FIG. 3, the alignment films 13 and 31 provided at such a position as to sandwich the liquid crystal layer LC from both sides are disposed such that the directions of the alignment axes (for example the direction of a rubbing process) of the alignment films 13 and 31 form an angle of 85° with the horizontal direction x, which is perpendicular to the extending direction of the comb tooth electrodes 51a. Suppose that the directions of the alignment axes of the alignment films 13 and 31 are antiparallel to each other. Suppose that this is common to the reflective display section 1r and the transmissive display section 1t.

In addition, suppose that the retardation layer 29 having a phase difference of λ/2 is provided maintaining a slow axis thereof at for example an angle of −28° with the horizontal direction x. Further, the polarizers 37 and 39 are disposed with transmission axes thereof in the form of crossed Nicols. The emission side polarizer 37 is disposed with the transmission axis thereof in parallel to the directions of the alignment axes of the alignment films 13 and 31. On the other hand, the incidence side polarizer 39 is disposed with the transmission axis thereof perpendicular to the directions of the alignment axes of the alignment films 13 and 31. Incidentally, a combination of directions of the transmission axes of the polarizers 37 and 39 with respect to the directions of the alignment axes of the alignment films 13 and 31 may be reversed as long as the transmission axes of the polarizers 37 and 39 are maintained in the form of crossed Nicols.

In a state of no voltage being applied between the pixel electrode 51 and the common electrode 5 in the liquid crystal display device 50 of such an optical configuration, the axis of the liquid crystal molecules m forming the liquid crystal layer LC is parallel with the alignment directions (85°) of the alignment films 13 and 31, and is aligned at an angle of 113° with the slow axis (−28°) of the retardation layer 29. Thereby, in the reflective display section 1r, a λ/4 layer in a wide band is formed by a combination of the liquid crystal layer LC and the λ/2 retardation layer 29. Light passing through the liquid crystal layer LC and the λ/2 retardation layer 29 in both ways rotates by 90° in the wide band, reaches the emission side polarizer 37 again, and is absorbed in the emission side polarizer 37 to make black display. On the other hand, light incident on the transmissive display section 1t from the incidence side polarizer 39 reaches the emission side polarizer 37 as it is without a phase difference being caused in the liquid crystal layer LC, and is absorbed in the emission side polarizer 37 to make black display.

In a state of voltage being applied between the pixel electrode 51 and the common electrode 5, the liquid crystal molecules m are rotated in one direction by a transverse electric field occurring between the comb tooth electrodes 51a of the pixel electrode 51, so that the liquid crystal layer LC does not cause a phase difference to light incident on the liquid crystal layer LC from the retardation layer 29. Thereby, in the reflective display section 1r, light incident from the emission side polarizer 37 rotates by 180° by passing through the λ/2 retardation layer 29 and the λ/4 liquid crystal layer LC in both ways, reaches the emission side polarizer 37 again, and passes through the emission side polarizer 37 to make white display. On the other hand, light incident on the transmissive display section 1t from the incidence side polarizer 39 rotates by 90° by passing through the λ/2 liquid crystal layer LC, reaches the emission side polarizer 37, and passes through the emission side polarizer 37 to make white display.

In the liquid crystal display device 50 of the above-described configuration, as described with reference to FIG. 2, the pixel electrode 51 is formed such that the width Wr of the reflective display section 1r is larger than the width Wt of the transmissive display section 1t. Therefore, when pixel electrodes 51 are arranged in a same direction, between pixel electrodes 51 adjacent to each other in the horizontal direction x, an interval dr between reflective display sections 1r is shorter than an interval dt between transmissive display sections 1t. Thus, the width Wr of the reflective display section 1r is increased, and it is possible to make display with an effective aperture ratio secured. On the other hand, in the transmissive display section 1t inherently having excellent color reproducibility, a color mixture is prevented by securing a long interval dt between pixel electrodes 51 adjacent to each other, so that color reproducibility can be ensured.

Then, in particular, because the plurality of comb tooth electrodes 51a are coupled to each other at only end parts, the pixel electrode 51 does not include an electrode part that disturbs an electric field occurring between the comb tooth electrodes 51a from the reflective display section 1r to the transmissive display section 1t, so that a uniform transverse electric field can be generated between the comb tooth electrodes 51a. In particular, the width and the arrangement interval p of the comb tooth electrodes 51a in the reflective display section 1r are substantially equal to the width and the arrangement interval p of the comb tooth electrodes 51a in the transmissive display section 1t, and each comb tooth electrode 51a is formed by a straight line. Therefore, a transverse electric field can be generated in a more uniform state between such comb tooth electrodes 51a within the pixel electrode 51. Thereby the liquid crystal molecules m can be aligned uniformly over the entire area of the pixel electrode 51.

As a result, the liquid crystal display device 50 according to the first embodiment can realize display suppressing the occurrence of a disclination line due to a disturbance of an electric field within a pixel and thus improve luminance while making liquid crystal display securing an aperture ratio in the reflective display section 1r and color reproducibility in the transmissive display section 1t.

### Second Embodiment

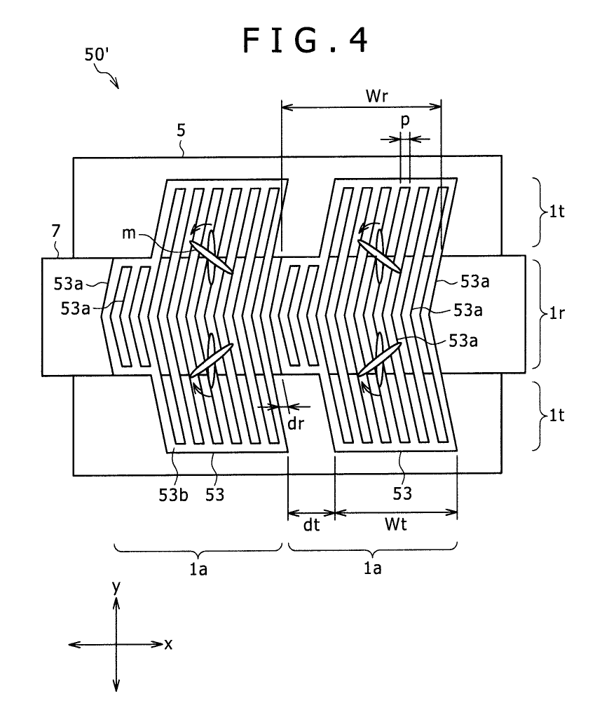

FIG. 4 is a schematic plan view of principal parts of two pixels of a liquid crystal display device according to a second embodiment.

The liquid crystal display device 50′ according to the second embodiment shown in FIG. 4 is a liquid crystal display device of a multi-domain configuration. Suppose that this liquid crystal display device 50′ is different from the liquid crystal display device 50 according to the first embodiment in terms of a state of arrangement of a reflective display section 1r and a transmissive display section 1t within a pixel 1a and the shape of a pixel electrode 53, and that the other configuration of the liquid crystal display device 50′ is similar to that of the first embodiment. In the following, repeated description of similar constituent elements to those of the first embodiment will be omitted.

In the liquid crystal display device 50′, each pixel 1a is for example of a substantially rectangular shape that is long in a vertical direction of a display screen, and a transmissive display section 1t, a reflective display section 1r, and a transmissive display section 1t are arranged in this order in the direction of long sides of each pixel 1a. A reflecting layer 7 provided so as to correspond to the reflective display section 1r is provided as a layer common to a plurality of pixels 1a arranged so as to be adjacent to each other in a horizontal direction x, and is disposed in a central part in a vertical direction y within a pixel 1a.

A pixel electrode 53 in the shape of comb teeth is formed by a plurality of comb tooth electrodes 53a. Each comb tooth electrode 53a is extended in the vertical direction y as the direction of arrangement of the reflective display section 1r and the transmissive display section 1t. Each comb tooth electrode 53a in this case has a characteristic shape that is bent in two directions at substantially the central part in the extending direction. Suppose that these comb tooth electrodes 53a are bent in two directions that form substantially the same angle with the vertical direction y. Suppose that this angle with the vertical direction y is about 5°, for example. Incidentally, suppose that the width and the arrangement interval p of such comb tooth electrodes 53a in the reflective display section 1r are substantially equal to the width and the arrangement interval p of the comb tooth electrodes 53a in the transmissive display sections 1t. In addition, as in the first embodiment, these comb tooth electrodes 53a are coupled to each other by a bridge electrode 53b at only end parts in the extending direction.

As in the first embodiment, the external shape of the pixel electrode 53 as described above is formed such that the width Wr of the reflective display section 1r is larger than the width Wt of the transmissive display sections 1t in the horizontal direction x as a direction of arrangement of the comb tooth electrodes 53a. The number of comb tooth electrodes 53a in the reflective display section 1r is therefore larger than the number of comb tooth electrodes 53a in the transmissive display sections 1t, and is for example larger by two than the number of comb tooth electrodes 53a in the transmissive display sections 1t in the example shown in FIG. 4. When the comb tooth electrodes 53a of the reflective display section 1r are increased by a plural number as compared with the transmissive display sections 1t, all the increased comb tooth electrodes 53a may be disposed in one direction of the reflective display section 1r as shown in FIG. 4, or may be divided and disposed on both sides of the reflective display section 1r.

In addition, as in the first embodiment, the pixel electrode 53 of such an external shape is disposed in each pixel 1a in a same direction. Therefore, between pixels 1a and 1a adjacent to each other in the horizontal direction x, an interval dr between pixel electrodes 53 in reflective display sections 1r is shorter than an interval dt between the pixel electrodes 53 in transmissive display sections 1t.

Further, as in the first embodiment, the pixel electrode 53 formed as described above is connected to a pixel circuit on a first substrate 1 with insulation from a common electrode 5 and the reflecting layer 7 retained.

In addition, suppose that the optical configuration and driving state of the liquid crystal display device 50′ provided with such pixel electrodes 53 are similar to those of the related-art configuration as described in the first embodiment. However, with voltage applied between the pixel electrode 53 and the common electrode 5, liquid crystal molecules m rotate in two directions to make white display, and thus display is made with an excellent viewing angle.

Also in the liquid crystal display device 50′ of such a configuration, as described with reference to FIG. 4, the pixel electrode 53 is formed such that the width Wr of the reflective display section 1r is larger than the width Wt of the transmissive display sections 1t in the horizontal direction x. Therefore, when pixel electrodes 53 are arranged in a same direction, between pixel electrodes 53 adjacent to each other in the horizontal direction x, the interval dr between reflective display sections 1r is shorter than the interval dt between transmissive display sections 1t. Thus, the width Wr of the reflective display section 1r is increased, and it is possible to make display with an effective aperture ratio secured. On the other hand, in the transmissive display sections 1t inherently having excellent color reproducibility, a color mixture is prevented by securing a long interval dt between pixel electrodes 53 adjacent to each other, so that color reproducibility can be ensured.

Then, in particular, because the plurality of comb tooth electrodes 53a are coupled to each other at only end parts, there is no electrode part that disturbs an electric field occurring between the comb tooth electrodes 53a from the reflective display section 1r to the transmissive display sections 1t, so that a uniform transverse electric field can be generated between the comb tooth electrodes 53a. In particular, the width and the arrangement interval p of the comb tooth electrodes 53a in the reflective display section 1r are substantially equal to the width and the arrangement interval p of the comb tooth electrodes 53a in the transmissive display sections 1t. Therefore, a transverse electric field can be generated in a more uniform state between such comb tooth electrodes 53a within the pixel electrode 53. Thereby the liquid crystal molecules m can be aligned uniformly over the entire area of the pixel electrode 53.

As a result, the liquid crystal display device 50′ of the multi-domain configuration according to the second embodiment can realize display suppressing the occurrence of a disclination line due to a disturbance of an electric field within a pixel and thus improve luminance while making liquid crystal display securing an aperture ratio in the reflective display section 1r and color reproducibility in the transmissive display sections 1t.

### Third Embodiment

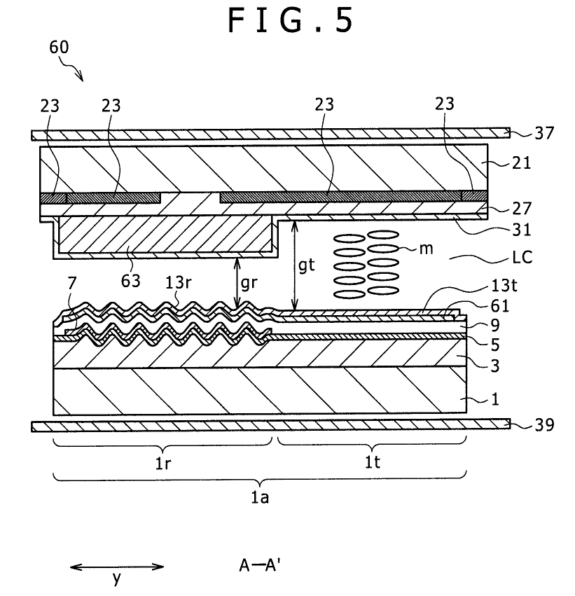

FIG. 5 is a schematic sectional view of principal parts of one pixel of a liquid crystal display device according to a third embodiment. FIG. 6 is a schematic plan view of principal parts of two pixels of the liquid crystal display device according to the third embodiment. A section along a comb tooth electrode in this plan view corresponds to FIG. 5.

The liquid crystal display device 60 according to the third embodiment shown in these figures has different states of alignment in a reflective display section 1r and a transmissive display section 1t. Suppose that this liquid crystal display device 60 is different from the liquid crystal display device 50 according to the first embodiment in terms of the shape of a pixel electrode 61 and an optical configuration, and that the other configuration of the liquid crystal display device 60 is similar to that of the first embodiment. In the following, repeated description of similar constituent elements to those of the first embodiment will be omitted.

A pixel electrode 61 in the shape of comb teeth is formed by a plurality of comb tooth electrodes 61a. Each comb tooth electrode 61a is extended in substantially a vertical direction y as a direction of arrangement of the reflective display section 1r and the transmissive display section 1t. Each comb tooth electrode 61a in this case has a characteristic shape that is bent in two directions at substantially a central part in the extending direction. Suppose for example that a part of these comb tooth electrodes 61a which part is disposed in the transmissive display section 1t are extended in parallel with the vertical direction y, and that a part of these comb tooth electrodes 61a which part is disposed in the reflective display section 1r are extended in a direction forming a predetermined angle with the vertical direction y. Suppose that this angle with the vertical direction y is about 60°, for example. Incidentally, suppose that the width and the arrangement interval p of such comb tooth electrodes 61a in the reflective display section 1r are substantially equal to the width and the arrangement interval p of the comb tooth electrodes 61a in the transmissive display section 1t. In addition, as in the first embodiment, these comb tooth electrodes 61a are coupled to each other by a bridge electrode 61b at only end parts in the extending direction.

As in the first embodiment, the external shape of the pixel electrode 61 as described above is formed such that the width Wr of the reflective display section 1r is larger than the width Wt of the transmissive display section 1t in the horizontal direction x as a direction of arrangement of the comb tooth electrodes 61a. The number of comb tooth electrodes 61a in the reflective display section 1r is therefore larger than the number of comb tooth electrodes 61a in the transmissive display section 1t, and is for example larger by two than the number of comb tooth electrodes 61a in the transmissive display section 1t in the example shown in FIG. 6. When the comb tooth electrodes 61a of the reflective display section 1r are increased by a plural number as compared with the transmissive display section 1t, all the increased part may be disposed in one direction of the reflective display section 1r as shown in FIG. 6, or may be divided and disposed on both sides of the reflective display section 1r.

Alignment films 13r and 13t for divided alignment in the reflective display section 1r and the transmissive display section 1t are provided on such a pixel electrode 61. For example, liquid crystal molecules in only the reflective display section 1r are aligned in a twisted state when no electric field is applied. Incidentally, details of the directions of alignment axes of the alignment films 13r and 13t will be described in conjunction with description below of an optical configuration.

A cell gap adjusting layer 63 formed of a transparent resist material is provided in place of the retardation layer on the second substrate 21 side of the liquid crystal display device 60. Suppose that the layer thickness of a liquid crystal layer LC in the reflective display section 1r (that is, a cell gap gr) and the layer thickness of the liquid crystal layer LC in the transmissive display section 1t (that is, a cell gap gt) are adjusted by the film thickness of the cell gap adjusting layer 63 according to an optical configuration to be described later. For example, suppose that these cell gaps gr and gt are set such that the liquid crystal layer LC in the reflective display section 1r has a phase difference of λ/4 and the liquid crystal layer LC in the transmissive display section 1t has a phase difference of λ/2 in a state in which voltage is applied between the pixel electrode 61 and a common electrode 5.

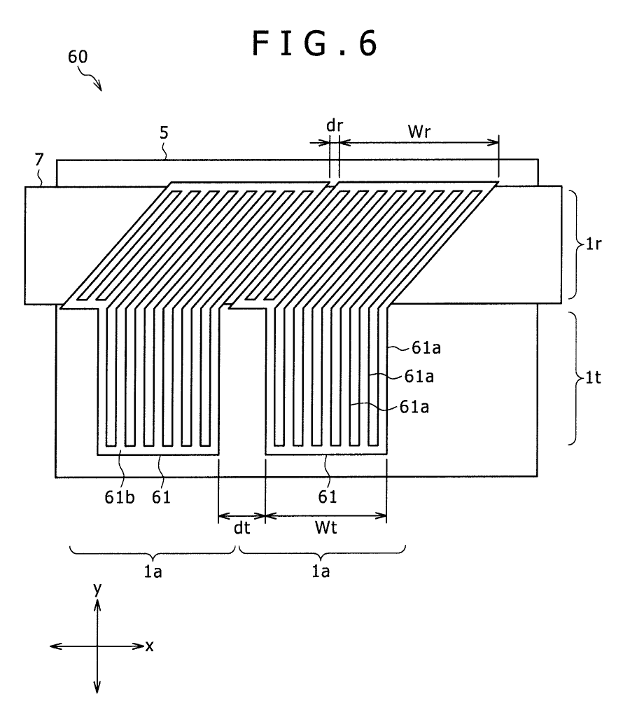

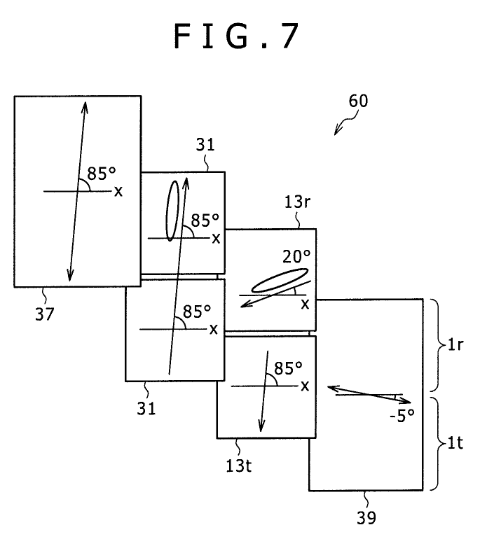

FIG. 7 is a diagram of assistance in explaining an example of optical configuration of such a liquid crystal display device 60. In FIG. 7, optical axes and alignment axes are indicated by arrows. Description will be made below of an example of optical configuration of the liquid crystal display device 60 while referring to FIG. 5 and FIG. 6 described earlier together with FIG. 7.

As shown in FIG. 7, of the alignment films 13r and 13t on the first substrate 1 side which films are provided at such a position as to sandwich the liquid crystal layer LC from both sides, the direction of an alignment axis of the alignment film 13r on the side of the reflective display section 1r forms an angle of 20° with the horizontal direction x as a direction perpendicular to the extending direction of the comb tooth electrodes 61a. The direction of an alignment axis of the alignment film 13t on the side of the transmissive display section 1t forms an angle of 85° with the horizontal direction x. On the other hand, an alignment film 31 on the second substrate 21 side is provided such that the direction of an alignment axis (for example the direction of a rubbing process) of the alignment film 31 forms an angle of 85° with the horizontal direction x, as in the first embodiment. Incidentally, suppose that the directions of the alignment axes of the alignment films 13t and 31 in the transmissive display section 1t are antiparallel to each other.

Polarizers 37 and 39 are disposed with transmission axes thereof in the form of crossed Nicols. The emission side polarizer 37 is disposed with the transmission axis thereof in parallel to the direction of the alignment axis of the alignment film 31. On the other hand, the incidence side polarizer 39 is disposed with the transmission axis thereof perpendicular to the direction of the alignment axis of the alignment film 31. Incidentally, a combination of directions of the transmission axes of the polarizers 37 and 39 with respect to the direction of the alignment axis of the alignment film 31 may be reversed as long as the transmission axes of the polarizers 37 and 39 are maintained in the form of crossed Nicols.

In a state of no voltage being applied between the pixel electrode 61 and the common electrode 5 in the liquid crystal display device 60 of such an optical configuration, the axis of the liquid crystal molecules m forming the liquid crystal layer LC in the reflective display section 1r is aligned while twisted between the alignment films 31 and 13r, thus resulting in black display. On the other hand, the axis of the liquid crystal molecules m in the transmissive display section 1t is aligned perpendicularly to the transmission axis of the incidence side polarizer 39 and in parallel with the transmission axis of the emission side polarizer 37. Thereby, light incident on the transmissive display section 1t from the incidence side polarizer 39 reaches the emission side polarizer 37 without a phase difference being caused in the liquid crystal layer LC, and is absorbed in the emission side polarizer 37 to make black display.

In a state of voltage being applied between the pixel electrode 61 and the common electrode 5, the liquid crystal molecules m are rotated in one direction by a transverse electric field occurring between the comb tooth electrodes 61a of the pixel electrode 61 to be aligned obliquely with respect to the transmission axes of the polarizers 37 and 39. The reflective display section 1r thereby makes white display. Light incident on the reflective display section 1r from the emission side polarizer 37 rotates by 180° by passing through the liquid crystal layer LC in both ways, reaches the emission side polarizer 37 again, and passes through the emission side polarizer 37 to make white display. On the other hand, light incident on the transmissive display section 1t from the incidence side polarizer 39 rotates by 90° by passing through the λ/2 liquid crystal layer LC, reaches the emission side polarizer 37, and passes through the emission side polarizer 37 to make white display.

Also in the liquid crystal display device 60 of such a configuration, as described with reference to FIG. 6, the pixel electrode 61 is formed such that the width Wr of the reflective display section 1r is larger than the width Wt of the transmissive display section 1t in the horizontal direction x. Therefore, when pixel electrodes 61 are arranged in a same direction, between pixel electrodes 61 adjacent to each other in the horizontal direction x, an interval dr between reflective display sections 1r is shorter than an interval dt between transmissive display sections 1t. Thus, the width Wr of the reflective display section 1r is increased, and it is possible to make display with an effective aperture ratio secured. On the other hand, in the transmissive display section 1t inherently having excellent color reproducibility, a color mixture is prevented by securing a long interval dt between pixel electrodes 61 adjacent to each other, so that color reproducibility can be ensured.

Then, in particular, because the plurality of comb tooth electrodes 61a are coupled to each other at only end parts, there is no electrode part that disturbs an electric field occurring between the comb tooth electrodes 61a from the reflective display section 1r to the transmissive display section 1t, so that a uniform transverse electric field can be generated between the comb tooth electrodes 61a. In particular, the width and the arrangement interval p of the comb tooth electrodes 61a in the reflective display section 1r are substantially equal to the width and the arrangement interval p of the comb tooth electrodes 61a in the transmissive display section 1t. Therefore, a transverse electric field can be generated in a more uniform state between such comb tooth electrodes 61a within the pixel electrode 61. Thereby the liquid crystal molecules m can be aligned uniformly over the entire area of the pixel electrode 61.

As a result, the liquid crystal display device 60 according to the third embodiment can realize display suppressing the occurrence of a disclination line due to a disturbance of an electric field within a pixel and thus improve luminance while making liquid crystal display securing an aperture ratio in the reflective display section 1r and color reproducibility in the transmissive display section 1t.

### <Circuit Configuration of Liquid Crystal Display Device>

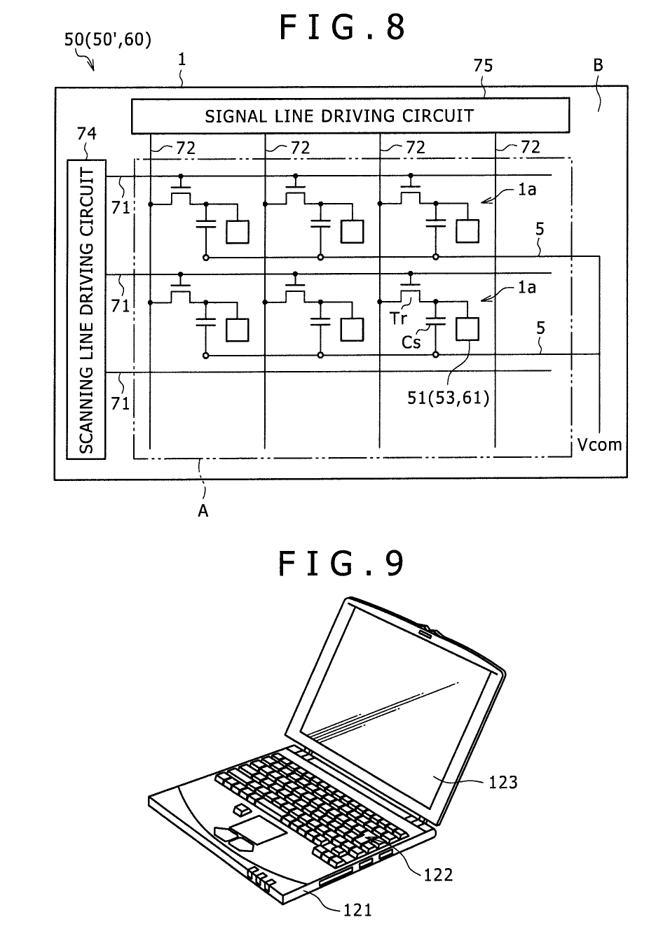

FIG. 8 is a diagram showing a circuit configuration of an active matrix driving liquid crystal display device to which the present invention is applied. Incidentally, description will be made with the same constituent elements as in the foregoing embodiments identified by the same reference numerals.

As shown in FIG. 8, a display area A and a peripheral area B thereof are set in the liquid crystal display device 50 (50′, 60). The display area A is formed as a pixel array unit in which a plurality of scanning lines 71 and a plurality of signal lines 72 are arranged horizontally and vertically and one pixel 1a is provided so as to correspond to each of intersection parts. In addition, a common electrode 5 common to each pixel 1a is provided in the display area A. On the other hand, a scanning line driving circuit 74 for scanning and driving the scanning lines 71 and a signal line driving circuit 75 for supplying a video signal (that is, an input signal) corresponding to luminance information to the signal lines 72 are disposed in the peripheral area B.

Each pixel 1a includes for example a pixel circuit composed of a thin film transistor Tr as a switching element and a storage capacitor Cs, and further includes a pixel electrode 51 (52, 61) connected to the pixel circuit. The storage capacitor Cs is formed between the common electrode 5 and the pixel electrode 51 (52, 61). The gate of the thin film transistor Tr is connected to a scanning line 71. One of the source and drain of the thin film transistor Tr is connected to a signal line 72. The other of the source and drain of the thin film transistor Tr is connected to the pixel electrode 51 (52, 61).

A video signal written from the signal line 72 via the thin film transistor Tr is retained by the storage capacitor Cs, and voltage corresponding to the amount of the retained signal is supplied to the pixel electrode 51 (52, 61).

The configuration of the pixel circuit as described above is a mere example. As required, a capacitive element may be provided within the pixel circuit, and a plurality of transistors may be further provided to form the pixel circuit. In addition, a necessary driving circuit may be added to the peripheral area B according to a change in the pixel circuit.

### <Examples of Application>

A display device according to an embodiment of the present invention described above can be applied to display devices of various electronic devices shown in FIGS. 9 to 13G, that is, electronic devices in all fields that display a video signal input thereto or a video signal generated therein as an image or video, such for example as digital cameras, notebook personal computers, portable terminal devices such as portable telephones and the like, and video cameras. An example of electronic devices to which the present invention is applied will be described in the following.

FIG. 9 is a perspective view of a notebook personal computer to which the present invention is applied. The notebook personal computer according to the present example of application includes a keyboard 122 operated to input characters and the like, a display part 123 for displaying an image, and the like in a main unit 121. The notebook personal computer is fabricated using a display device according to an embodiment of the present invention as the display part 123.

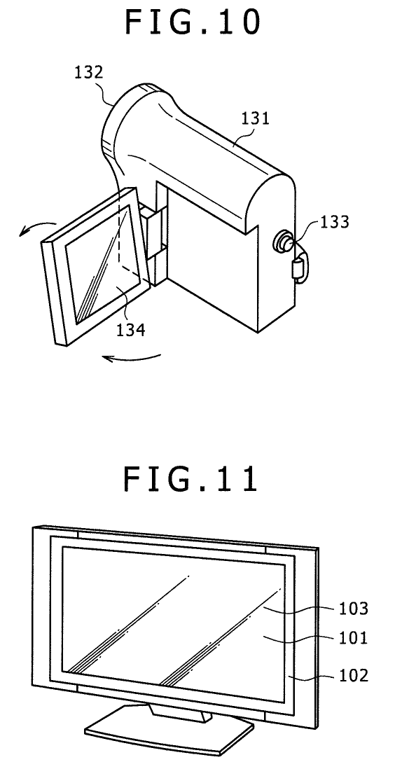

FIG. 10 is a perspective view of a video camera to which the present invention is applied. The video camera according to the present example of application includes a main unit 131, a lens 132 for taking a subject in a side surface facing frontward, a start/stop switch 133 at a time of picture taking, a display part 134, and the like. The video camera is fabricated using a display device according to an embodiment of the present invention as the display part 134.

FIG. 11 is a perspective view of a television set to which the present invention is applied. The television set according to the present example of application includes a video display screen part 101 composed of a front panel 102, a filter glass 103 and the like. The television set is fabricated using a display device according to an embodiment of the present invention as the video display screen part 101.

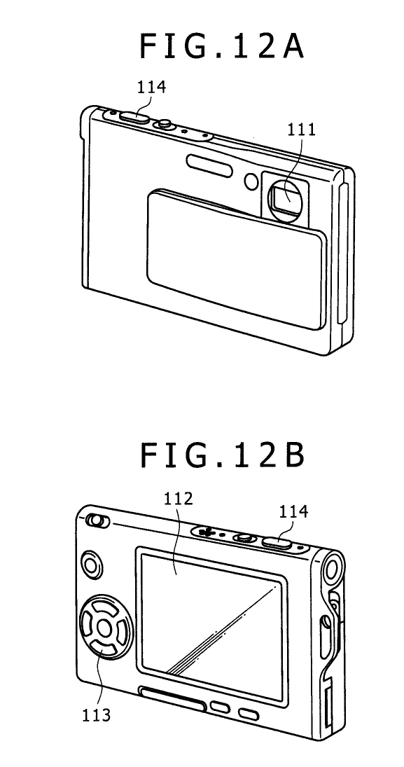

FIGS. 12A and 12B are diagrams showing a digital camera to which the present invention is applied. FIG. 12A is a perspective view of the digital camera as viewed from a front side, and FIG. 12B is a perspective view of the digital camera as viewed from a back side. The digital camera according to the present example of application includes a light emitting part 111 for flashlight, a display part 112, a menu switch 113, a shutter button 114, and the like. The digital camera is fabricated using a display device according to an embodiment of the present invention as the display part 112.

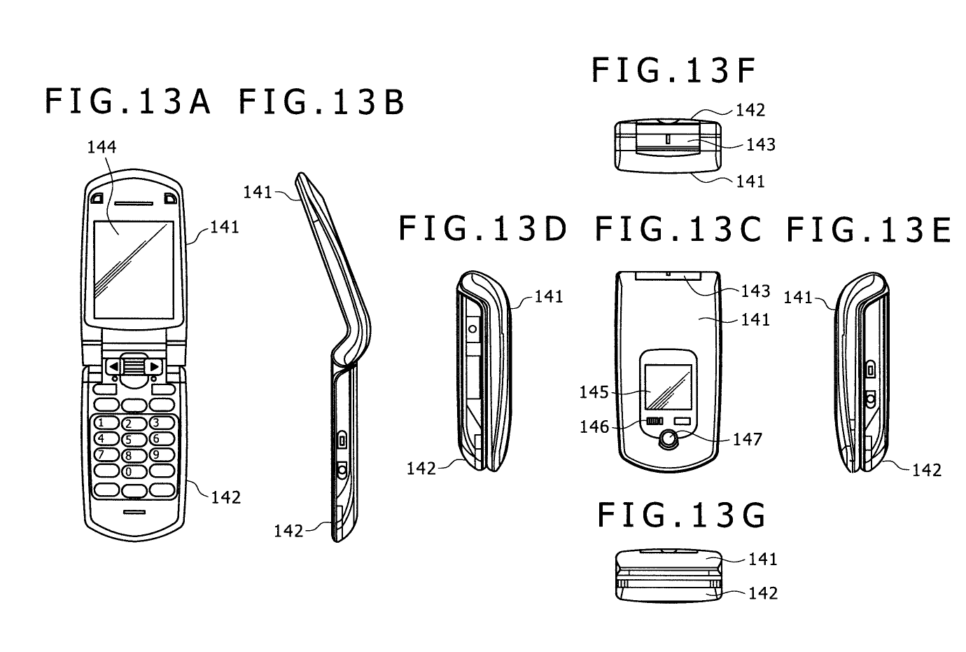

FIGS. 13A, 13B, 13C, 13D, 13E, 13F, and 13G are diagrams showing a portable terminal device, for example a portable telephone to which the present invention is applied. FIG. 13A is a front view of the portable telephone in an opened state, FIG. 13B is a side view of the portable telephone in the opened state, FIG. 13C is a front view of the portable telephone in a closed state, FIG. 13D is a left side view of the portable telephone in the closed state, FIG. 13E is a right side view of the portable telephone in the closed state, FIG. 13F is a top view of the portable telephone in the closed state, and FIG. 13G is a bottom view of the portable telephone in the closed state. The portable telephone according to the present example of application includes an upper side casing 141, a lower side casing 142, a coupling part (a hinge part in this case) 143, a display 144, a sub-display 145, a picture light 146, a camera 147, and the like. The portable telephone is fabricated using a display device according to an embodiment of the present invention as the display 144 and the sub-display 145.

### EXAMPLES

Liquid crystal display devices according to embodiments of the present invention described above and a liquid crystal display device according to a comparison example were fabricated as follows, and transmittance and reflectance were measured.

A liquid crystal display device 50 similar to the first embodiment described with reference to FIG. 2 was fabricated as a first example. In addition, a liquid crystal display device 50′ similar to the second embodiment described with reference to FIG. 4 was fabricated as a second example.

The shape of a pixel electrode in each of the liquid crystal display devices is as follows. Width Wr is 50 μm, width Wt is 40 μm, the width of comb tooth electrodes is 4 μm, an arrangement interval p of the comb tooth electrodes is 4 μm, the length of a reflective display section in the vertical direction y is 40 μm, the length of a transmissive display section in the vertical direction y is 100 μm, and an angle of a bend in the comb tooth electrodes 53a with the vertical direction y in the second example (see FIG. 4) is 5°.

A related-art liquid crystal display device 200 as described with reference to FIG. 14 was fabricated as a comparison example. As for the shape of a pixel electrode, the width of comb tooth electrodes in a reflective display section 1r is 3 μm, an arrangement interval pr of the comb tooth electrodes in the reflective display section 1r is 3 μm, the width of comb tooth electrodes in a transmissive display section 1t is 4 μm, and an arrangement interval pt of the comb tooth electrodes in the transmissive display section 1t is 4 μm. The shape of the pixel electrode is otherwise the same as in the first and second examples.

The transmittance and reflectance of each of the fabricated liquid crystal display devices in white display were measured. Results of the measurement are shown in Table 1 below. Incidentally, transmittance (measuring device: Photo Research, Inc., PR-705) is a value when the luminance of a backlight light source is 100%, and reflectance (measuring device: manufactured by MINOLTA, CM2002 SCE-Mode) is a value when the reflectance of a standard white plate is 100%.

TABLE 1

| | FIRST | SECOND | COMPARISON |
|---|---|---|---|
| | EXAMPLE | EXAMPLE | EXAMPLE |
| | (FIG. 2) | (FIG. 4) | (FIG. 14) |
| REFLECTANCE | 4.00% | 4.00% | 3.00% |
| TRANSMITTANCE | 6.00% | 6.00% | 5.40% |

As shown in Table 1, it has been confirmed that the liquid crystal display devices according to the first and second examples to which the present invention is applied and which have a configuration without a bridge electrode for coupling comb tooth electrodes to each other between the reflective display section and the transmissive display section suppress the occurrence of a domain at a time of white display, and are improved in both reflectance and transmittance and thus have excellent characteristics as compared with the liquid crystal display device of the related-art configuration as the comparison example to which the above configuration is not applied.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device having a pixel electrode in a shape of comb teeth, said pixel electrode including a plurality of comb tooth electrodes arranged in one direction, and having a reflective display section and a transmissive display section in each pixel,
wherein said pixel electrode is formed such that width of said reflective display section is larger than width of said transmissive display section in a direction perpendicular to a direction of arrangement of said reflective display section and said transmissive display section, and
said plurality of comb tooth electrodes are coupled to each other at only an end part.

2. The liquid crystal display device according to claim 1,
wherein each of said comb tooth electrodes is extended in the direction of arrangement of said reflective display section and said transmissive display section, and a number of said comb tooth electrodes in said reflective display section is larger than a number of said comb tooth electrodes in said transmissive display section.

3. The liquid crystal display device according to claim 1,
wherein each of said comb tooth electrodes is extended in the direction of arrangement of said reflective display section and said transmissive display section, and is formed by a straight line.

4. The liquid crystal display device according to claim 1,
wherein said pixel electrode is disposed in a same direction in each said pixel, and
between pixels arranged so as to be adjacent to each other in the direction perpendicular to the direction of arrangement of said reflective display section and said transmissive display section among said pixels, an interval between said pixel electrodes in said reflective display sections is shorter than an interval between said pixel electrodes in said transmissive display sections.

5. The liquid crystal display device according to claim 4,
wherein a reflecting layer is disposed so as to be laid over said pixel electrode in said reflective display section, and
said reflecting layer is disposed as a common layer between a plurality of pixels including said reflective display sections disposed so as to be adjacent to each other.

6. The liquid crystal display device according to claim 1,
wherein said comb tooth electrodes are bent in two directions at substantially a center in an extending direction.

7. The liquid crystal display device according to claim 1,
wherein a retardation layer is pattern-formed in said reflective display section, and layer thickness of a liquid crystal layer in said reflective display section and said transmissive display section is adjusted by said retardation layer.

8. The liquid crystal display device according to claim 1, wherein a state of alignment of a liquid crystal molecule differs between said reflective display section and said transmissive display section.
